(19) United States
(12) Patent Application Publication
(10) Pub. No.: US 2026/0273346 A1
(43) Pub. Date: Sep. 17, 2026

(54) CLIMBING STICK

(71) Applicant: Latitude Outdoors, LLC, Grand Rapids, MI (US)

(72) Inventors: Kevin Leach, Grand Rapids, MI (US); Alex Chopp, Royal Oka, MI (US); Jake Matelic, Royal Oak, MI (US)

(73) Assignee: Latitude Outdoors, LLC, Grand Rapids, MI (US)

(21) Appl. No.: 19/677,000

(22) Filed: May 14, 2026

Related U.S. Application Data
(63) Continuation of application No. 18/828,633, filed on Sep. 9, 2024.
Application No. 18/828,633 is a continuation of application No. 17/829,835, filed on Jun. 1, 2022, now abandoned.
(63) Continuation of application No. 18/327,268, filed on Jun. 1, 2023, now Pat. No. 12,674,356.

(51) Int. Cl. A63B 29/08; A45B 7/00; E06C 1/34; E06C 1/38; E06C 7/08

(52) U.S. Cl. CPC A63B 29/08; A45B 7/00; E06C 1/34; E06C 1/381; E06C 7/08

(57) ABSTRACT

An injection-molded climbing stick includes a first step, a second step, and a post extending from the first step to the second step along a length of the post and comprising a plurality of fibers that includes every fiber that is disposed within the post. The plurality of fibers includes a sub-plurality of fibers. Each fiber in the sub-plurality of fibers is elongated in a lengthwise direction of the fiber and oriented such that the lengthwise direction is substantially parallel to the length of the post, and the sub-plurality of fibers includes a majority of the fibers in the plurality of fibers.

### CROSS-REFERENCE TO RELATED APPLICATIONS

This application is a continuation-in-part that claims priority to and the benefit of U.S. patent application Ser. No. 18/828,633, filed Sep. 9, 2024, entitled “CLIMBING STICK,” and U.S. patent application Ser. No. 17/829,835 filed on Jun. 1, 2022, entitled “CLIMBING STICK,” which U.S. patent application Ser. No. 18/828,633 is a continuation of. This application also claims priority to and the benefit of U.S. patent application Ser. No. 18/327,268, filed Jun. 1, 2023, entitled “CLIMBING STICK.” The present application claims priority to each of these applications, and each of these applications is incorporated herein by reference in its entirety.

### BACKGROUND OF THE DISCLOSURE

The present disclosure generally relates to a climbing stick. More specifically, the present disclosure relates to an injection-molded climbing stick that includes a plurality of fibers.

### SUMMARY OF THE DISCLOSURE

According to one aspect of the present disclosure, an injection-molded climbing stick includes a first step, a second step, and a post extending from the first step to the second step along a length of the post and comprising a plurality of fibers that includes every fiber that is disposed within the post. The plurality of fibers includes a sub-plurality of fibers. Further, each fiber in the sub-plurality of fibers is elongated in a lengthwise direction of the fiber and oriented such that the lengthwise direction is substantially parallel to the length of the post, and the sub-plurality of fibers includes a majority of the fibers in the plurality of fibers.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front elevational view of a climbing stick.

FIG. 2 is a top perspective view of a climbing stick.

FIG. 3 is a bottom perspective view of a climbing stick.

FIG. 4 is a rear elevational view of a climbing stick.

FIG. 5 is a bottom perspective view of a rear side of a climbing stick.

FIG. 6 is a side elevational view of a climbing stick.

FIG. 7 is a top plan view of a climbing stick.

FIG. 8 is a bottom plan view of a climbing stick.

FIG. 9 is a front elevational view of a climbing stick, illustrating a direction that is parallel to a length of a post of the climbing stick.

FIG. 10 is a schematic representation of area X of the post of FIG. 9, illustrating fibers disposed within the post.

FIG. 11 is a schematic representation of area XI of a standoff wall of FIG. 8, illustrating fibers disposed within the standoff wall.

FIG. 12 is a front elevational view of a climbing stick.

FIG. 13 is a top perspective view of a climbing stick.

FIG. 14 is a rear elevational view of a climbing stick.

FIG. 15 is an enlarged view of a portion of the climbing stick of FIG. 14.

FIG. 16 is a bottom perspective view of a rear side of a climbing stick.

FIG. 17 is a bottom plan view of a climbing stick.

FIG. 18 is a schematic representation of area XVIII of a standoff wall of the climbing stick of FIG. 17.

The components in the figures are not necessarily to scale, emphasis instead being placed upon illustrating the principles described herein.

### DETAILED DESCRIPTION

The present illustrated embodiments reside primarily in apparatus components related to a climbing stick. Accordingly, the apparatus components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

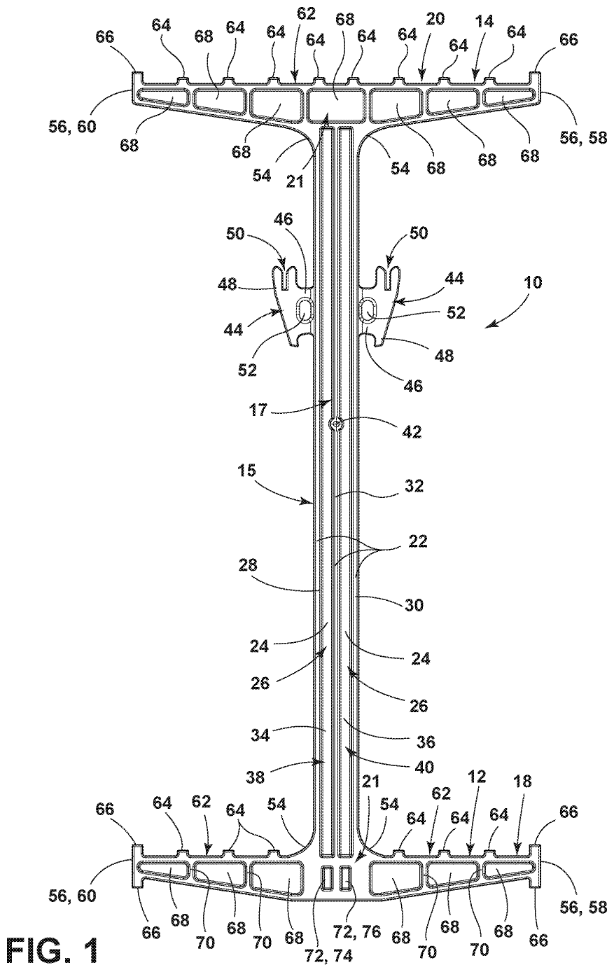

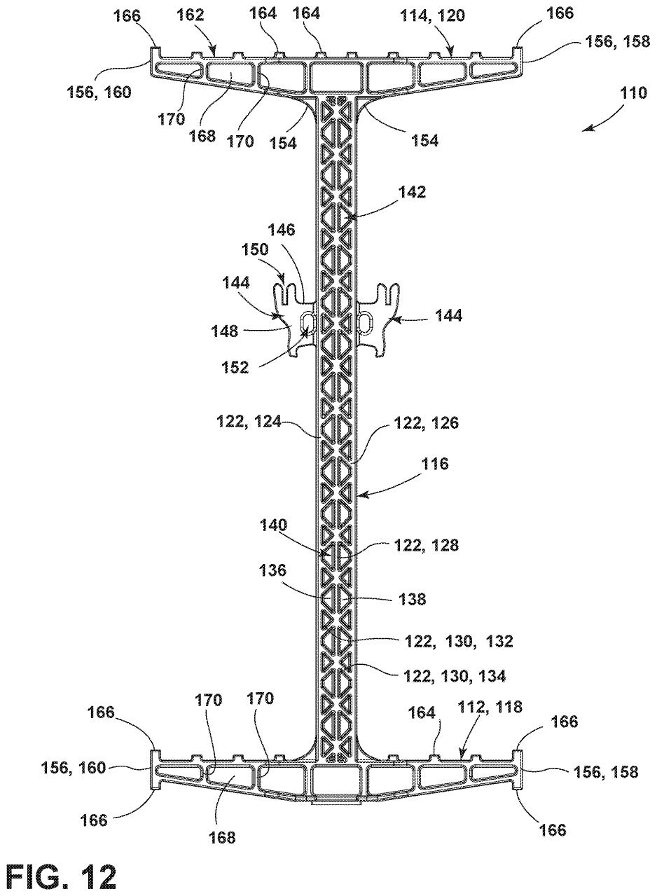

For purposes of description herein, the terms “upper,” “lower,” “right,” “left,” “lateral,” “rear,” “front,” “vertical,” “horizontal,” “upward,” “downward” and derivatives thereof shall relate to the disclosure as oriented in FIG. 1 and/or FIG. 12. Unless stated otherwise, the term “front” shall refer to the surface of the element closer to an intended viewer, and the term “rear” shall refer to the surface of the element further from the intended viewer. Unless stated otherwise, the term “forward” shall refer to toward the intended viewer and/or closer to the intended viewer based on the context. For example, the phrase “extending forward” shall be interpreted as extending toward the intended viewer, while a first element being “forward of” a second element shall refer to the first element being closer than the second element to the intended viewer. Unless stated otherwise, the term “rearward” shall refer to away from the intended viewer and/or further from the intended viewer based on the context. For example, the phrase “extending rearward” shall be interpreted as extending away from the intended viewer, while a first element being “rearward of” a second element shall refer to the first element being further than the second element from the intended viewer. Unless stated otherwise, the term “lateral” and derivatives thereof shall refer to left-right directions. However, it is to be understood that the disclosure may assume various alternative orientations, except where expressly specified to the contrary. It is also to be understood that the specific devices illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

For purposes of this disclosure, the term “coupled” (in all of its forms: couple, coupling, coupled, etc.) generally means the joining of two components (electrical or mechanical) directly or indirectly to one another. Such joining may be stationary or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

Thus, for example, reference to “a component” includes embodiments having two or more such components unless the context clearly indicates otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element being preceded by “comprises a.” does not, without more constraints, preclude the existence of additional identical elements in the process, method, article, or apparatus that comprises the element.

Referring to FIGS. 1-10, reference numeral 10 generally designates a climbing stick. The climbing stick 10 may be an injection-molded climbing stick 10, as described further herein. The injection-molded climbing stick 10 includes a first step 12, a second step 14, and a post 15. The post 15 extends from the first step 12 to the second step 14 along a length of the post 15. The post 15 comprises a plurality of fibers 16 that includes every fiber 16 that is disposed within the post 15. The plurality of fibers 16 includes a sub-plurality of fibers 16. Each fiber 16 in the sub-plurality of fibers 16 is elongated in a lengthwise direction of the fiber 16 and oriented such that the lengthwise direction is substantially parallel to the length of the post 15. The sub-plurality of fibers 16 includes a majority of the fibers 16 in the plurality of fibers 16.

Referring now to FIGS. 1-6, the climbing stick 10 includes the first step 12, the second step 14, and the post 15 that extends between the first and second steps 12, 14. In the embodiment illustrated in FIG. 1, the first step 12 of the climbing stick 10 is a bottom step 18, and the second step 14 is a top step 20 that is positioned upward of the bottom step 18. In various implementations, the first step 12 may be the top step 20 and the second step 14 may be the bottom step 18 positioned downward of the top step 20. The post 15 of the climbing stick 10 extends from the first step 12 to the second step 14 along the length of the post 15.

The post 15 can include a plurality of walls 22 that protrude outward from at least one floor portion 24 of the post 15 and, further, extend in a lengthwise direction L of the post 15 (i.e., along the length of the post 15). The plurality of walls 22 and the at least one floor portion 24 of the post 15 may cooperate to define at least one channel 26 that extends along the length of the post 15. For example, as illustrated in FIGS. 1-3, the post 15 includes a first outer wall 28 that extends in the lengthwise direction L of the post 15, a second outer wall 30 that extends in the lengthwise direction L of the post 15, and an inner wall 32 that extends in the lengthwise direction L of the post 15. The inner wall 32 is positioned between the first and second outer walls 28, 30.

In the embodiment illustrated in FIG. 1, a first floor portion 34 extends in the lengthwise direction L of the post 15 and extends between the first outer wall 28 and the inner wall 32. A second floor portion 36 extends in the lengthwise direction L of the post 15 and extends between the second outer wall 30 and the inner wall 32. The first outer wall 28, the inner wall 32, and the first floor portion 34 define a first channel 38 that extends along the lengthwise direction L of the post 15. The second outer wall 30, the inner wall 32, and the second floor portion 36 define a second channel 40 that extends along the lengthwise direction L of the post 15. As illustrated in FIG. 1, the surfaces of the first and second floor portions 34, 36 of the post 15 that define the first and second channels 38, 40, respectively, face forward. Further, the inner wall 32 and the first and second outer walls 28, 30 extend forward from the first and second floor portions 34, 36.

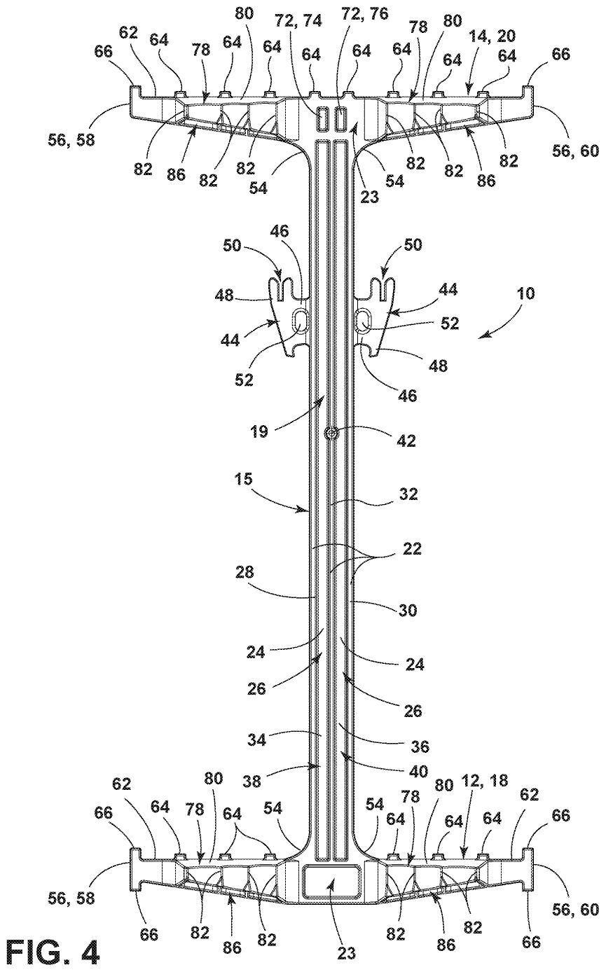

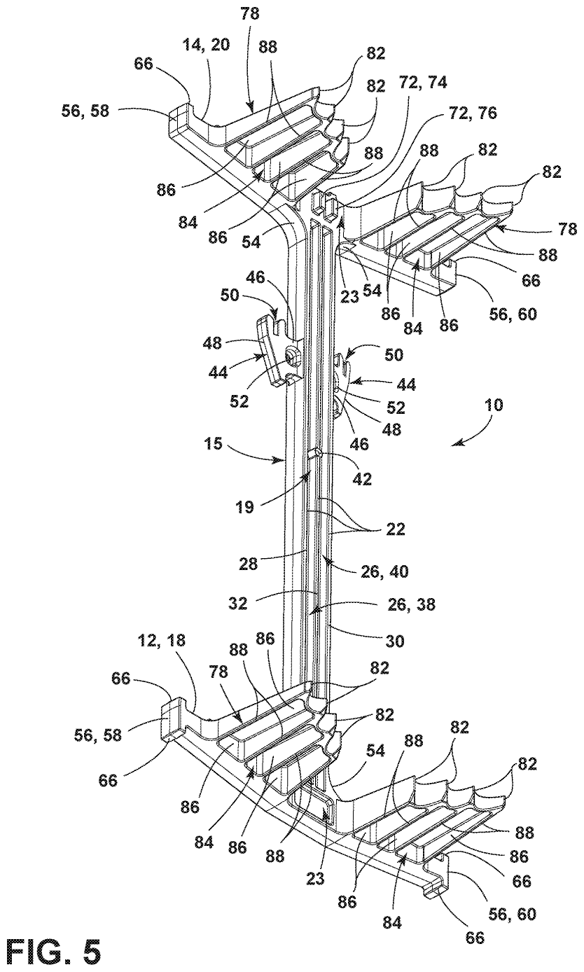

Referring now to FIGS. 4 and 5, in some embodiments, the post 15 includes at least one floor portion 24 that includes a channel-defining surface that faces rearward. For example, as illustrated in FIGS. 4 and 5, the post 15 includes first and second floor portions 34, 36 that face rearward and an inner wall 32 and first and second outer walls 28, 30 that extend rearward from the first and second floor portions 34, 36. As such, first and second channels 38, 40 are defined on the rear side 19 of the post 15. In various embodiments, one or more channels 26 can be defined on the front side 17 of the post 15 and the rear side 19 of the post 15. For example, the post 15 can include first and second floor portions 34, 36, an inner wall 32, and first and second outer walls 28, 30 that cooperate to define first and second channels 38, 40 on both the front and rear sides 17, 19 of the post 15. It is contemplated that one or more channels 38, 40 that are defined by the front and/or rear sides 17, 19 of the post 15 may extend beyond the post 15, such that the one or more channels 38, 40 are additionally defined by portions of the first and/or second steps 12, 14.

Referring now to FIGS. 1-5, the post 15 can define an aperture 42. As illustrated in FIGS. 1-5, the inner wall 32 of the post 15 at least partially defines the aperture 42 that extends through the post 15. In various embodiments, the inner wall 32 wholly defines the aperture 42 that extends through the post 15. The aperture 42 defined by the post 15 may be configured to receive a fastener for attaching a strap to the post 15 of the climbing stick 10 for selectively strapping multiple climbing sticks 10 together for transportation purposes.

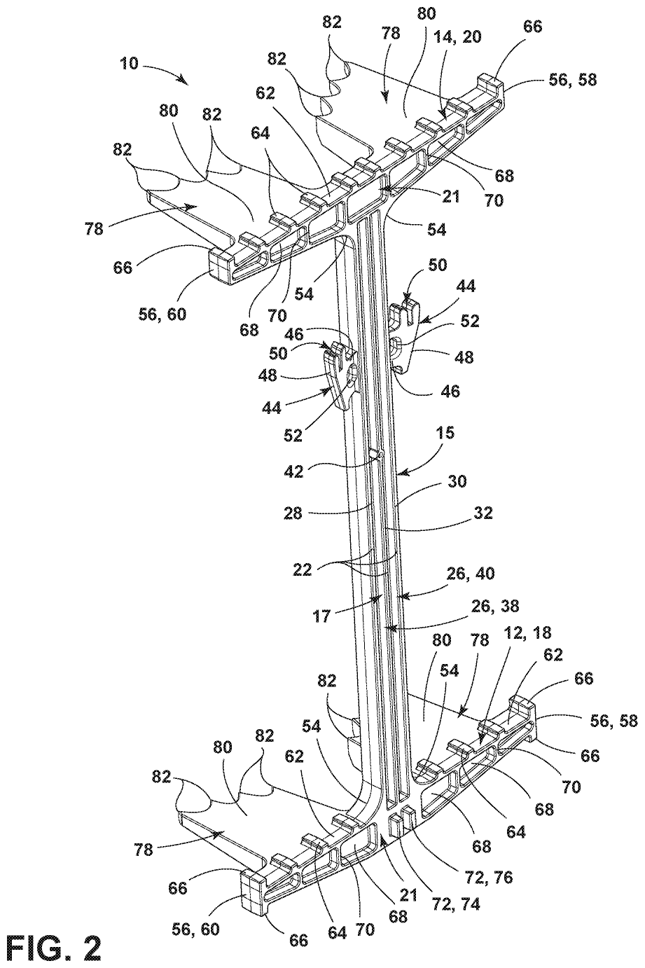

Referring now to FIGS. 1-8, the climbing stick 10 can include a cleat 44. In various embodiments, the climbing stick 10 can include a plurality of cleats 44. For example, as illustrated in FIGS. 1-5, the climbing stick 10 includes two cleats 44. The cleat 44 is coupled to the post 15 between the first and second steps 12, 14 of the climbing stick 10. In various embodiments, the cleat 44 is coupled to the post 15 between the front and rear sides 17, 19 of the post 15, as illustrated in FIGS. 2, 3, 5, and 6. The cleat 44 includes a neck 46 that is coupled to the post 15 and extends outward therefrom. The cleat 44 further includes a head 48 that is coupled to the neck 46 distally from the post 15. In various implementations, the head 48 defines a slot 50. In the embodiment illustrated in FIG. 2, the slot 50 is defined on an upper side of the head 48, such that the slot 50 faces generally upward toward the second step 14 (i.e., the top step 20). It is contemplated that the slot 50 may face a variety of directions in various embodiments. In some embodiments, the slot 50 defined by the cleat 44 may have a width of about two millimeters. The slot 50 being about 2 mm wide may snugly accommodate certain types of rope that may be used to secure the climbing stick 10 to a tree, such as PARACORD®. In some implementations, the cleat 44 defines a cleat aperture 52. For example, as illustrated in FIGS. 1-5, the neck 46 of the cleat 44 defines a cleat aperture 52.

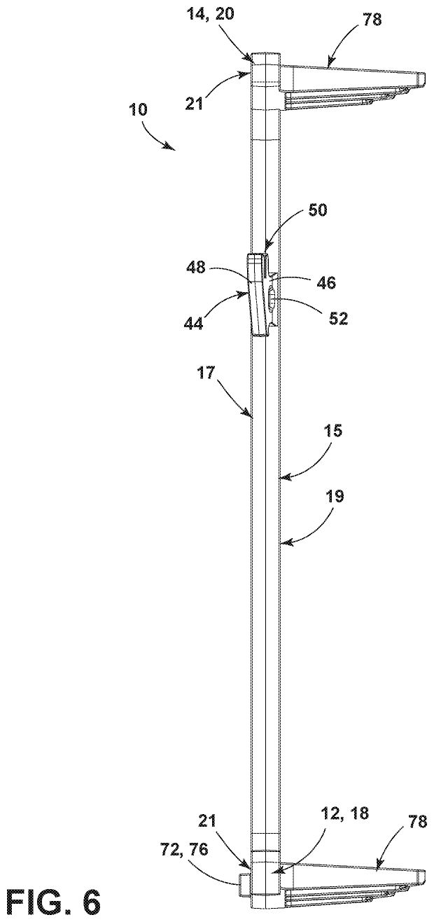

Referring now to FIG. 6, in some implementations, the cleat 44 coupled to the post 15 of the climbing stick 10 angles forward and laterally-outboard from the post 15. In various embodiments, the cleat 44 is angled, such that a portion of the cleat 44 is positioned further forward than the forward-most surface of the post 15. For example, as illustrated in FIG. 6, a portion of the cleat 44 that is distal from the post 15 extends forward beyond the forward-most surface of the post 15. In various embodiments, the portion of the neck 46 of the cleat 44 that is proximal to the post 15 may be positioned wholly between the forward-most surface of the post 15 and the rearward-most surface of the post 15.

Referring now to FIGS. 1-8, the climbing stick 10 includes the first and second steps 12, 14. In the illustrated embodiments, the first step 12 is the bottom step 18 and the second step 14 is the top step 20 positioned upward of the bottom step 18. As illustrated in FIG. 1, the post 15 extends between the first and second steps 12, 14 and is coupled to the first and second steps 12, 14 at corners 54. As illustrated, the corners 54 are generally rounded, which may advantageously influence resin flow and fiber orientation during injection molding of the climbing stick 10, as described further herein. As further illustrated in FIG. 1, the first and second steps 12, 14 extend laterally-outboard from the post 15 to laterally-distal ends 56 of the first and second steps 12, 14, respectively. In other words, as illustrated in FIG. 1, the first step 12 extends outward from the post 15 to the right to a right laterally-distal end 58 of the first step 12, and the first step 12 extends outward from the post 15 to the left to a left laterally-distal end 60 of the first step 12. Further, the second step 14 extends outward from the post 15 to the right to a right laterally-distal end 58 of the second step 14, and the second step 14 extends outward from the post 15 to the left to a left laterally-distal end 60 of the second step 14.

The first and second steps 12, 14 each include an upper stepping surface 62. The upper stepping surface 62 faces upward and is configured to support the foot of a user standing on the first and/or second step 12, 14. As illustrated in FIGS. 1-4, a plurality of traction ridges 64 extend upward from the upper stepping surfaces 62 of the first and second steps 12, 14. The traction ridges 64 extend in a forward-rearward direction and are spaced apart from each other in the lateral direction along the upper stepping surface 62 of each of the first and second steps 12, 14.

As illustrated in FIG. 1, the first step 12 includes a tang 66 that extends downward from the first step 12 away from the second step 14. It is contemplated that the first step 12 may include a plurality of tangs 66 that extend downward from the first step 12. For example, in the embodiment illustrated in FIG. 1, the first step 12 includes two tangs 66 that extend downward from the first step 12. The tang 66 may extend downward at the laterally-distal end 56 of the first step 12, in some embodiments. For example, in the embodiment illustrated in FIG. 1, the two tangs 66 of the first step 12 extend downward from the first step 12 at the left and right laterally-distal ends 60, 58 of the first step 12, respectively.

Referring still to FIG. 1, the second step 14 can include a tang 66 that extends upward from the second step 14 away from the first step 12. The second step 14 can include a plurality of tangs 66 that extend upward from the second step 14. For example, as illustrated in FIG. 1, the second step 14 includes two tangs 66 that extend upward from the second step 14. The tang 66 of the second step 14 can extend upward at the laterally-distal end 56 of the second step 14. For example, as illustrated in FIG. 1, the two tangs 66 of the second step 14 extend upward from the second step 14 at the left and right laterally-distal ends 60, 58 of the second step 14, respectively.

In various implementations, the tang 66 of the second step 14 can extend upward from the upper stepping surface 62 of the second step 14 further than the traction ridges 64 of the second step 14 extend upward from the upper stepping surface 62 of the second step 14. In some embodiments, one or more of the tangs 66 of the first and second steps 12, 14 are laterally aligned with each other. In other words, the tang 66 of the first step 12 and the tang 66 of the second step 14 may be positioned relative to each other such that both tangs 66 fall within a plane extending normal to the lateral direction. In the embodiment illustrated in FIG. 1, the tang 66 positioned at the left laterally-distal end 60 of the first step 12 is laterally aligned with the tang 66 positioned at the left laterally-distal end 60 of the second step 14. Further, the tang 66 of the right laterally-distal end 58 of the first step 12 is laterally aligned with the tang 66 of the right laterally-distal end 58 of the second step 14.

In some embodiments, the first step 12 can include at least one tang 66 that extends upward from the laterally-distal ends 56 of the first step 12. For example, in the embodiment illustrated in FIG. 1, two tangs 66 extend upward from the left and right laterally-distal ends 60, 58 of the first step 12, and two tangs 66 extend downward from the left and right laterally-distal ends 60, 58 of the first step 12. In operation, the upward extending tangs 66 of the first and second steps 12, 14, which extend upward from the laterally-distal ends 56 of the first and second steps 12, 14, respectively, can serve as a tactile indication of where the laterally-distal ends 56 of the first and second steps 12, 14 are while the user is climbing. Further, the downward extending tangs 66 of the first step 12 and the upward extending tangs 66 of the second step 14 may act as hooks that can retain rope coiled about the first and second steps 12, 14.

Referring now to FIGS. 1-3, the first and/or second steps 12, 14 can define a plurality of step recesses 68. In various embodiments, the front side 21 of the first step 12 and/or the front side 21 of the second step 14 defines the plurality of step recesses 68. As illustrated in FIG. 1, the plurality of step recesses 68 may be separated from each other and partially defined by one or more step walls 70. As illustrated in FIG. 1, the step walls 70 may extend generally parallel to the length of the post 15 and may have substantially the same lateral width as the inner wall 32 of the post 15. The first and/or second steps 12, 14 defining the step recesses 68 separated by the step walls 70 may advantageously influence the flow of resin and the orientation of fibers 16 within the climbing stick 10 during the injection molding process, such that the structural integrity of the climbing stick 10 is enhanced.

Referring now to FIGS. 1-8, the climbing stick 10 can include a protrusion 72. In various embodiments, the climbing stick 10 includes a plurality of protrusions 72. In some embodiments, at least one protrusion 72 extends outward from at least one of the first and second steps 12, 14 in a forward direction. It is contemplated that the at least one protrusion 72 can extend outward from the front and/or rear side 17, 19 of the post 15, in some embodiments. The at least one protrusion 72 can be laterally aligned with the at least one channel 26 defined by the post 15 of the climbing stick 10. As illustrated in FIGS. 1-3, the climbing stick 10 includes first and second protrusions 74, 76 that extend forward from the first step 12 and are positioned to be laterally aligned with the first and second channels 38, 40 of the post 15, respectively. The first and second protrusions 74, 76 are offset from the channels 26 of the post 15 in the forward direction. In various embodiments, a lateral width of the at least one protrusion 72 can be less than the lateral width of the at least one channel 26 of the post 15. As illustrated in FIGS. 1-3, the first protrusion 74 extends outward from the first step 12 in the forward direction and is laterally aligned with the first channel 38 of the post 15. The lateral width of the first protrusion 74 is less than the lateral width of the first channel 38. Further, the second protrusion 76 extends outward from the first step 12 of the climbing stick 10 in the forward direction. The second protrusion 76 is laterally aligned with the second channel 40, and the lateral width of the second protrusion 76 is less than the lateral width of the second channel 40 defined by the post 15.

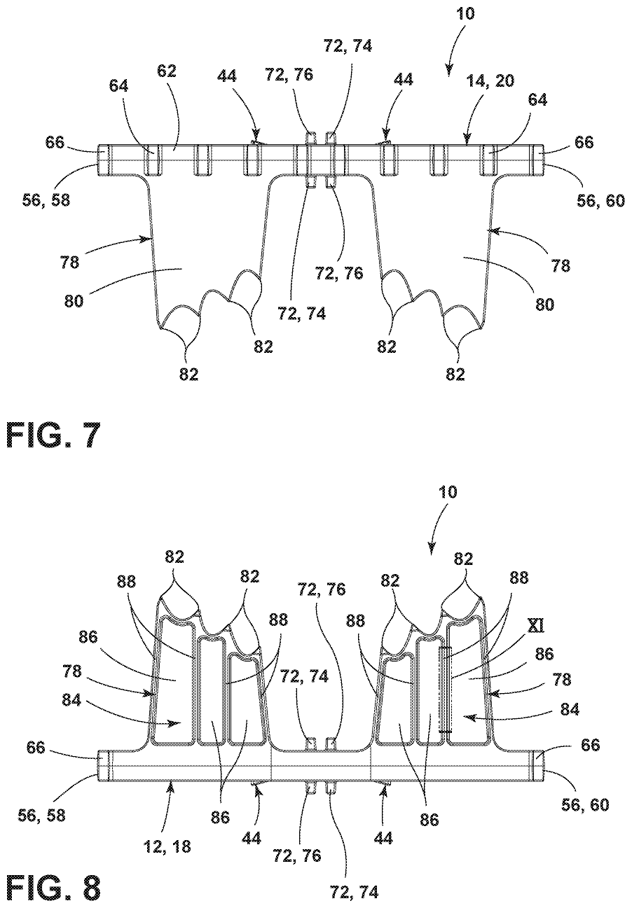

Referring now to FIGS. 4-8, the climbing stick 10 can include at least one protrusion 72 that extends rearward from a rear side 23 of at least one of the first and second steps 12, 14. As illustrated in FIGS. 4-6, first and second protrusions 74, 76 extend rearward from the second step 14 of the climbing stick 10. The first and second protrusions 74, 76 extending rearward from the second step 14 are laterally aligned with first and second channels 38, 40, respectively, that are defined on the rear side 19 of the post 15. In various embodiments, the climbing stick 10 can include at least one protrusion 72 that extends forward from at least one of the first and second steps 12, 14 and at least one protrusion 72 that extends rearward from at least one of the first and second steps 12, 14. For example, as illustrated in FIGS. 7 and 8, the climbing stick 10 includes first and second protrusions 74, 76 that extend forward from the first step 12 and first and second protrusions 74, 76 that extend rearward from the second step 14. In operation, the protrusions 72 of the climbing stick 10 are configured to slidingly engage with channels 26 of additional climbing sticks 10 such that multiple climbing sticks may be engaged with each other in a stacked configuration for convenient, compact transportation.

Referring now to FIGS. 2-8, the climbing stick 10 includes at least one standoff 78. The at least one standoff 78 is configured to engage with a tree while the climbing stick 10 is in use. In various embodiments, the climbing stick 10 includes a plurality of standoffs 78 that are configured to engage with a tree. The at least one standoff 78 can extend rearward from the first and/or second steps 12, 14 of the climbing stick 10. In the embodiment illustrated in FIGS. 2-8, the climbing stick 10 includes two standoffs 78 that extend rearward from the first step 12 and two standoffs 78 that extend rearward from the second step 14. As illustrated in FIGS. 2-5, 7, and 8, each standoff 78 of the climbing stick 10 is positioned laterally between one of the laterally-distal ends 56 of one of the first and second steps 12, 14 and the post 15 of the climbing stick 10. As shown in FIGS. 1 and 2, upper surfaces 80 of the standoffs 78 that extend rearward from the first step 12 may be substantially flush with the upper stepping surface 62 of the first step 12 adjacent to the first step 12. Further, the upper surfaces 80 of the standoffs 78 that extend rearward from the second step 14 may be substantially flush with the upper stepping surface 62 of the second step 14 adjacent to the second step 14.

Referring now to FIGS. 2, 3, 5, 7, and 8, the at least one standoff 78 coupled to the first step 12 may extend rearward from the first step 12 to a plurality of teeth 82 that are distal from the first step 12. Further, the at least one standoff 78 coupled to the second step 14 may extend rearward from the second step 14 to a plurality of teeth 82. The plurality of teeth 82 may be configured to engage with a tree trunk during use of the climbing stick 10.

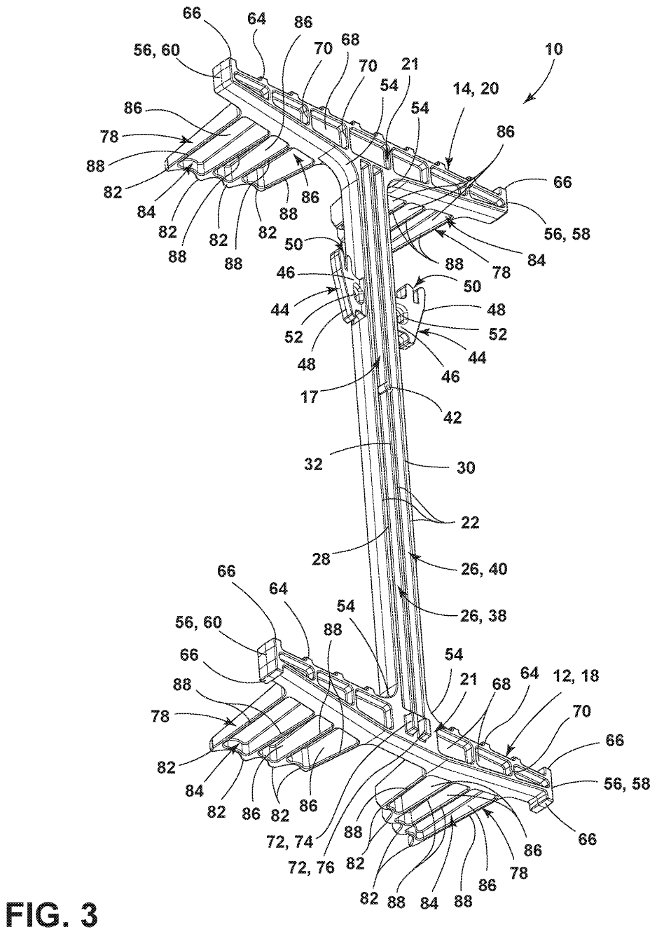

In various embodiments, a bottom side 84 of the at least one standoff 78 of the climbing stick 10 defines a plurality of standoff recesses 86. The plurality of standoff recesses 86 can be separated from each other and/or partially defined by a plurality of standoff walls 88, as illustrated in FIGS. 3, 5, and 8. At least one standoff wall 88 may extend rearward from the first and/or second steps 12, 14 along a length of the at least one standoff wall 88. In some implementations, one or more standoff walls 88 may extend rearward from the first and/or second steps 12, 14 and generally align with the teeth 82 of the at least one standoff 78, as illustrated in FIG. 8. In some embodiments, the length of the at least one standoff wall 88 may be substantially perpendicular to the length of the post 15. The at least one standoff 78 having a plurality of standoff recesses 86 that are separated by and partially defined by standoff walls 88 may advantageously influence the flow of resin and the orientation of fibers 100 during injection molding of the climbing stick 10, such that the structural integrity of the climbing stick 10 is enhanced. Further, the orientation of fibers 100 within the at least one standoff wall 88 may enhance the structural integrity of the at least one standoff 78, as described further herein.

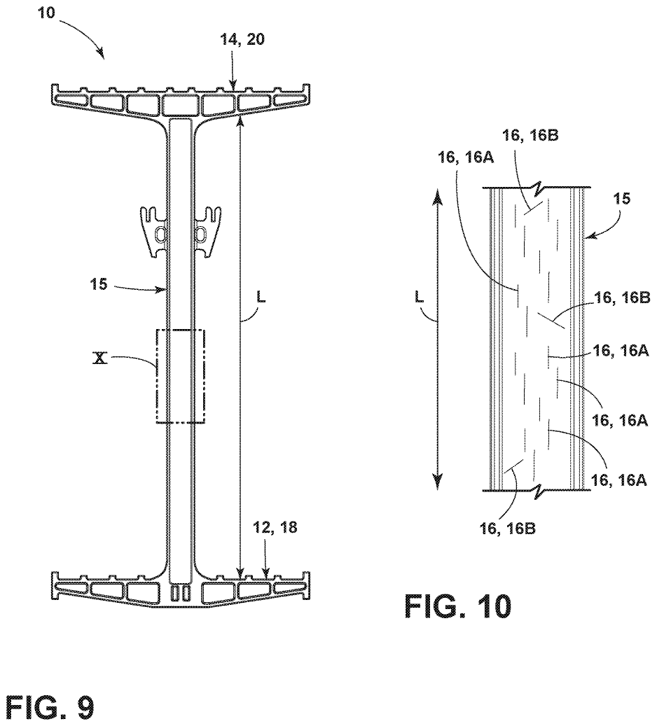

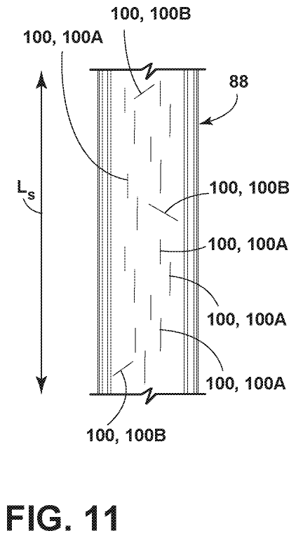

Referring now to FIGS. 9 and 10, the climbing stick 10 can be an injection-molded climbing stick 10. As such, the climbing stick 10 may be formed of a resin that is injected into a mold and cooled to form an integral component. A variety of types of resins, such as thermoplastics, are contemplated. Further, a variety of types of thermoplastics are contemplated. The injection-molded climbing stick 10 may further be formed of a plurality of fibers 16 that are disposed within the resin. A variety of types of fibers 16 are contemplated. For example, the injection-molded climbing stick 10 may include one or more of a host of types of fibers 16 that may include, but is not limited to, carbon, glass, aramid, basalt, polyacrylonitrile, polyethylene terephthalate, and/or polypropylene fibers. Further, the injection-molded climbing stick 10 can include long fibers 16 and/or short fibers 16. In an exemplary embodiment, the injection-molded climbing stick 10 is formed of a thermoplastic resin and short carbon fibers 16. As such, the climbing stick 10 is a short carbon fiber-reinforced thermoplastic climbing stick 10. Various combinations of resins and fibers 16 are contemplated.

In various embodiments, fibers 16 disposed within the climbing stick 10 are aligned with each other and/or aligned with a given climbing stick-direction to enhance the structural integrity of the climbing stick 10. For example, fibers 16 disposed within the post 15 of the climbing stick 10 may be aligned with each other along the length of the post 15. In an exemplary embodiment, wherein the post 15 extends from the first step 12 to the second step 14 along the length of the post 15, the post 15 comprises a plurality of fibers 16 that includes every fiber 16 that is disposed within the post 15 of the climbing stick 10. The plurality of fibers 16 includes a sub-plurality of fibers 16. Each fiber 16 in the sub-plurality of fibers 16 is elongated in a lengthwise direction of the fiber. Further, each fiber 16A in the sub-plurality of fibers 16 is oriented such that the lengthwise direction is substantially parallel to the length of the post 15. In various embodiments, the plurality of fibers 16 that includes every fiber 16 that is disposed within the post 15 includes fibers 16B that are not oriented such that the lengthwise direction of the fiber 16B is substantially parallel to the length of the post 15. For example, as illustrated in FIG. 10, there are fibers 16A that are substantially parallel relative to the length of the post 15 and fibers 16B that are not substantially parallel relative to the length of the post 15.

In various embodiments, the sub-plurality of fibers 16 includes a majority of the fibers 16 in the plurality of fibers 16 disposed within the post 15. In some embodiments, the sub-plurality of fibers 16 includes between about 60% and 100% of the fibers 16 in the plurality of fibers 16. In some embodiments, the sub-plurality of fibers 16 includes between about 75% and 100% of the fibers 16 in the plurality of fibers 16. In some embodiments, the sub-plurality of fibers 16 includes between about 90% and 100% of the fibers 16 in the plurality of fibers 16. In some embodiments, the sub-plurality of fibers 16 includes between about 95% and 100% of the fibers 16 in the plurality of fibers 16. In some embodiments, the sub-plurality of fibers 16 includes between about 99% and 100% of the fibers 16 in the plurality of fibers 16.

In various embodiments, fibers 16 are oriented substantially parallel to the length of the post 15 when the lengthwise direction of the fiber 16 is angled less than about 30 degrees relative to the length of the post 15. In some embodiments, substantially parallel to the length of the post 15 is an angle of less than about 15 degrees relative to the length of the post 15. In some embodiments, substantially parallel to the length of the post 15 is an angle of less than about 10 degrees relative to the length of the post 15. In some embodiments, substantially parallel to the length of the post 15 is an angle of less than about 5 degrees relative to the length of the post 15.

In some embodiments, fibers 100 disposed within the at least one standoff wall 88 are aligned with each other along the length Lₛ of the standoff wall 88. In an exemplary embodiment, wherein the standoff wall 88 extends rearward from the first step 12 along the length of the standoff wall 88, the standoff wall 88 comprises a plurality of fibers 100 that includes every fiber 100 that is disposed within the standoff wall 88 of the climbing stick 10. The plurality of fibers 100 within the standoff wall 88 includes a sub-plurality of fibers 100A. Each fiber 100A in the sub-plurality of fibers 100A is elongated in the lengthwise direction of the fiber 100A. Further, each fiber 100A in the sub-plurality of fibers 100A is oriented such that the lengthwise direction is substantially parallel to the length of the standoff wall 88. In various embodiments, the plurality of fibers 100 that includes every fiber 100 that is disposed within the standoff wall 88 includes fibers 100B that are not oriented such that the lengthwise direction of the fiber 100B is substantially parallel to the length of the standoff wall 88.

In various embodiments, the sub-plurality of fibers 100A includes a majority of the fibers 100 in the plurality of fibers 100 disposed within the standoff wall 88. In some embodiments, the sub-plurality of fibers 100A includes between about 60% and 100% of the fibers 100 in the plurality of fibers 100 disposed within the standoff wall 88. In some embodiments, the sub-plurality of fibers 100A includes between about 75% and 100% of the fibers 100 in the plurality of fibers 100 disposed within the standoff wall 88. In some embodiments, the sub-plurality of fibers 100A includes between about 90% and 100% of the fibers 100 in the plurality of fibers 100 disposed within the standoff wall 88. In some embodiments, the sub-plurality of fibers 100A includes between about 95% and 100% of the fibers 100 in the plurality of fibers 100 disposed within the standoff wall 88. In some embodiments, the sub-plurality of fibers 100A includes between about 99% and 100% of the fibers 100 in the plurality of fibers 100 disposed within the standoff wall 88.

In various embodiments, fibers 100 are oriented substantially parallel to the length of the standoff wall 88 when the lengthwise direction of the fiber 100 is angled less than about 30 degrees relative to the length of the standoff wall 88. In some embodiments, substantially parallel to the length of the standoff wall 88 is an angle of less than about 15 degrees relative to the length of the standoff wall 88. In some embodiments, substantially parallel to the length of the standoff wall 88 is an angle of less than about 10 degrees relative to the length of the standoff wall 88. In some embodiments, substantially parallel to the length of the standoff wall 88 is an angle of less than about 5 degrees relative to the length of the standoff wall 88.

The present disclosure may provide a variety of advantages. First, forming the climbing stick 10 from a thermoplastic resin via injection molding results in the climbing stick 10 being significantly lighter than similarly sized climbing sticks 10 that are formed of conventional materials, such as metal. Second, despite the reduced weight of the climbing stick 10 enabled by use of the thermoplastic material, the sub-plurality of fibers 16A that are oriented substantially parallel with the length of the post 15 of the climbing stick 10 ensure that the climbing stick 10 has sufficient structural integrity for conventional use. Third, the channels 26 defined by the post 15 contribute to climbing stick weight reduction, influence resin flow and fiber 16 orientation within the post 15, and are configured to receive protrusions 72 of other climbing sticks 10 therein, such that multiple climbing sticks 10 may be slidingly engaged with each other for convenient, compact storage and transportation. Fourth, the cleat 44 angling forward and outboard from the post 15 of the climbing stick 10 may increase the ease with which a user can fasten the climbing stick 10 to a tree by providing additional space between the tree and the rear side of the cleat 44. Fifth, the first and second steps 12, 14 including downward and upward extending tangs 66, respectively, may allow a user to securely coil the tag end of a rope about the first and second steps 12, 14 of the climbing stick 10. Sixth, the step recesses 68 and standoff recesses 86 being separated from each other by the step walls 70 and standoff walls 88, respectively, may advantageously influence the flow of resin and the orientation of fibers 16, 100 within the resin during injection molding of the climbing stick 10 to increase the structural integrity of the climbing stick 10 while reducing the overall weight of the climbing stick 10.

Referring to FIGS. 12-18, reference numeral 110 generally designates a climbing stick. The climbing stick 110 includes a first step 112, a second step 114, and a post 116 that extends between the first and second steps 112, 114. In the embodiment illustrated in FIG. 12, the first step 112 of the climbing stick 110 is a bottom step 118 and the second step 114 is a top step 120 that is positioned upward of the bottom step 118. In various implementations, the first step 112 may be the top step 120 and the second step 114 may be the bottom step 118 positioned downward of the top step 120. The post 116 of the climbing stick 110 extends from the first step 112 to the second step 114 along a length of the post 116.

The post 116 can include a plurality of walls 122 that protrude outward from at least one floor portion of the post 116. One or more of the plurality of walls 122 may extend in a lengthwise direction of the post 116 (i.e., along the length of the post 116). For example, as illustrated in FIG. 12, the post 116 includes a first outer wall 124 that extends in the lengthwise direction of the post 116, a second outer wall 126 that extends in the lengthwise direction of the post 116, and an inner wall 128 that extends in the lengthwise direction of the post 116. The inner wall 128 is positioned between the first and second outer walls 124, 126.

The plurality of walls 122 of the post 116 may include one or more diagonal walls 130. In the embodiment illustrated in FIG. 12, the post 116 includes a plurality of first diagonal walls 132 and a plurality of second diagonal walls 134. Each of the first diagonal walls 132 extends upward and rightward from the first outer wall 124 of the post 116 to the second outer wall 126. Each of the second diagonal walls 134 of the post 116 extends upward and leftward from the second outer wall 126 to the first outer wall 124. As illustrated in FIG. 12, the pluralities of first and second diagonal walls 132, 134 extend diagonally between the first and second outer walls 124, 126 relative to the lengthwise direction of extension of the first and second outer walls 124, 126.

Referring still to FIG. 12, a first floor portion 136 extends in the lengthwise direction of the post 116 and extends between the first outer wall 124 and the inner wall 128. As illustrated in FIG. 12, the first floor portion 136 is interrupted by the pluralities of first and second diagonal walls 132, 134. As such, the first outer wall 124, the inner wall 128, the plurality of first diagonal walls 132, the plurality of second diagonal walls 134, and the first floor portion 136 cooperate to define a plurality of first pockets 140 that are disposed along the post 116.

A second floor portion 138 extends in the lengthwise direction of the post 116 and extends between the second outer wall 126 and the inner wall 128. As illustrated in FIG. 12, the second floor portion 138 is interrupted by the pluralities of first and second diagonal walls 132, 134. As such, the second outer wall 126, the inner wall 128, the plurality of first diagonal walls 132, the plurality of second diagonal walls 134, and the second floor portion 138 cooperate to define a plurality of second pockets 142 disposed along the length of the post 116. As illustrated in FIG. 12, the inner wall 128 is disposed laterally between the plurality of first pockets 140 and the plurality of second pockets 142 defined by the post 116 of the climbing stick 110. In the embodiment illustrated in FIG. 12, the first and second floor portions 136, 138 face forward. Further, the inner wall 128, the first and second outer walls 124, 126, the plurality of first diagonal walls 132, and the plurality of second diagonal walls 134 extend forward from the first and second floor portions 136, 138.

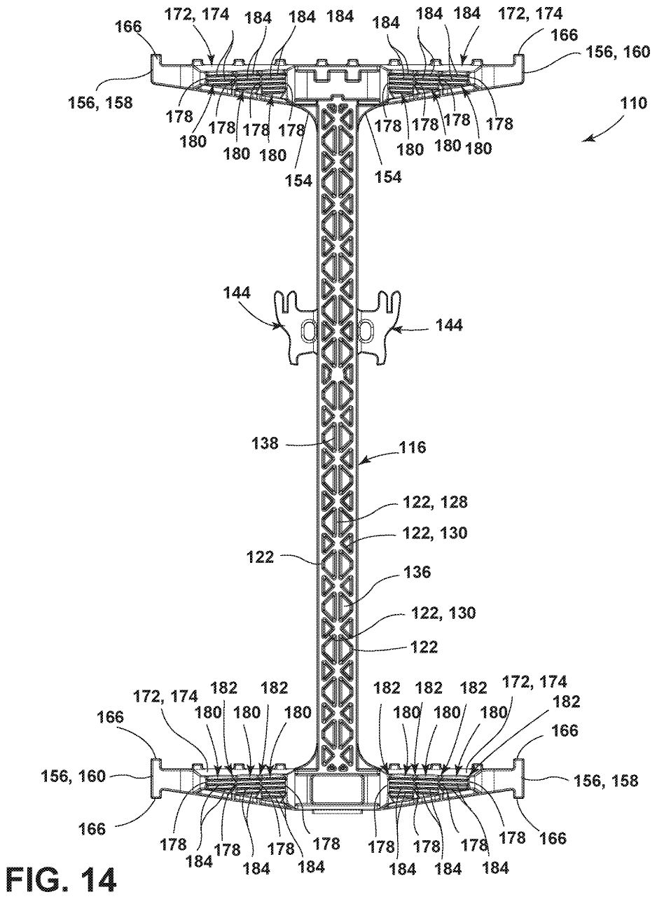

Referring now to FIG. 14, in various implementations, at least one floor portion of the post 116 includes a channel-defining surface that faces rearward. In the embodiment illustrated in FIG. 14, the post 116 includes first and second floor portions that face rearward. Further, the post 116 includes an inner wall 128, first and second outer walls 124, 126, a plurality of first diagonal walls 132, and a plurality of second diagonal walls 134 that extend rearward from the first and second floor portions 136, 138. As such, the post 116 defines a plurality of first pockets 140 on the rear side of the post 116 and a plurality of second pockets 142 on the rear side of the post 116. In various embodiments, one or more pockets 140, 142 can be defined on the front side of the post 116 and the rear side of the post 116.

Referring now to FIGS. 12-14, the climbing stick 110 can include a cleat 144. In various embodiments, the climbing stick 110 can include a plurality of cleats 144. For example, as illustrated in FIGS. 12-14, the climbing stick 110 includes two cleats 144. The cleat 144 is coupled to the post 116 between the first and second steps 112, 114 of the climbing stick 110. In various embodiments, the cleat 144 is coupled to the post 116 between the front and rear sides of the post 116. The cleat 144 includes a neck 146 that is coupled to the post 116 and extends outward therefrom. The cleat 144 further includes a head 148 that is coupled to the neck 146 distally from the post 116. In various implementations, the head 148 defines a slot 150. In the embodiment illustrated in FIG. 12, the slot 150 is defined on an upper side of the head 148, such that the slot 150 faces generally upward toward the second step 114 (i.e., the top step 120). It is contemplated that the slot 150 may face a variety of directions in various embodiments. In some embodiments, the slot 150 defined by the cleat 144 may have a width of about 2 mm. The slot 150 being about 2 mm wide may snugly accommodate certain types of rope that may be used to secure the climbing stick 110 to a tree, such as PARACORD®. In some implementations, the cleat 144 defines a cleat aperture 152. For example, as illustrated in FIGS. 12-14, the cleat 144 defines a cleat aperture 152.

Referring now to FIGS. 12-16, the climbing stick 110 includes the first and second steps 112, 114. In the illustrated embodiments, the first step 112 is the bottom step 118 and the second step 114 is the top step 120 positioned upward of the bottom step 118. As illustrated in FIG. 12, the post 116 extends between the first and second steps 112, 114 and is coupled to the first and second steps 112, 114 at corners 154. As illustrated, the corners 154 are generally rounded, which may advantageously influence resin flow and fiber orientation during injection molding of the climbing stick 110, as described further herein. As further illustrated in FIG. 12, the first and second steps 112, 114 extend laterally-outboard from the post 116 to laterally-distal ends 156 of the first and second steps 112, 114, respectively. In other words, as illustrated in FIG. 12, the first step 112 extends outward from the post 116 to the right to a right laterally-distal end 158 of the first step 112, and the first step 112 extends outward from the post 116 to the left to a left laterally-distal end 160 of the first step 112. Further, a second step 114 extends outward from the post 116 to the right to a right laterally-distal end 158 of the second step 114, and the second step 114 extends outward from the post 116 to the left to a left laterally-distal end 160 of the second step 114.

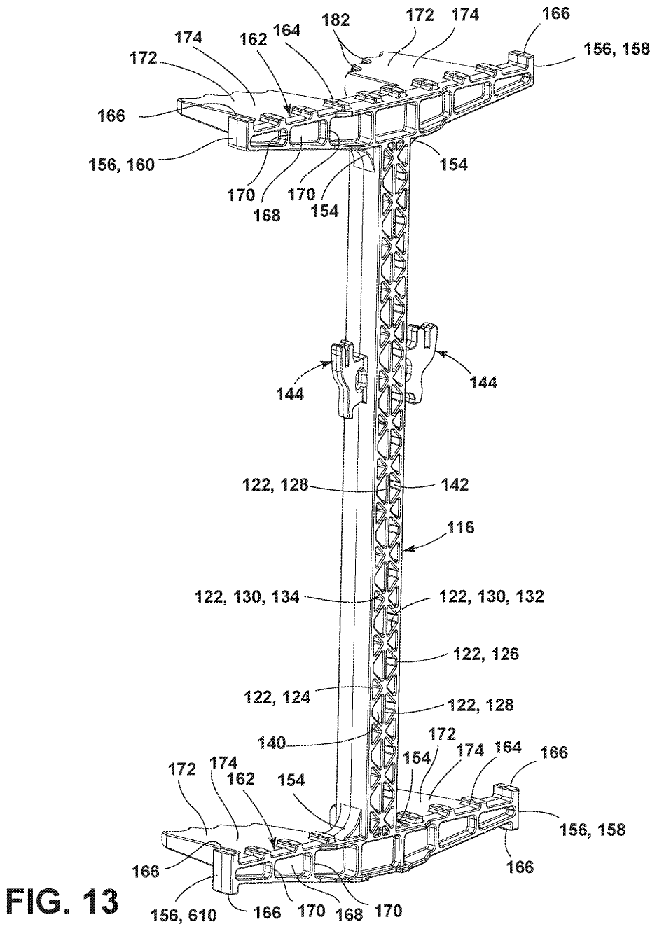

The first and second steps 112, 114 each include an upper stepping surface 162. The upper stepping surface 162 faces upward and is configured to support the foot of a user standing on the first and/or second steps 112, 114. As illustrated in FIGS. 12 and 13, a plurality of traction ridges 164 extend upward from the upper stepping surfaces 162 of the first and second steps 112, 114. The traction ridges 164 extend in a forward-rearward direction and are spaced apart from each other in the lateral direction along the upper stepping surface 162 of each of the first and second steps 112, 114.

As illustrated in FIG. 12, the first step 112 includes a tang 166 that extends downward from the first step 112 away from the second step 114. It is contemplated that the first step 112 may include a plurality of tangs 166 that extend downward from the first step 112. For example, in the embodiment illustrated in FIG. 12, the first step 112 includes two tangs 166 that extend downward from the first step 112. The tang 166 may extend outward at the laterally-distal end 156 of the first step 112, in some embodiments. For example, in the embodiment illustrated in FIG. 12, the two tangs 166 of the first step 112 extend downward from the first step 112 at the left and right laterally-distal ends 160, 158 of the first step 112, respectively.

Referring still to FIG. 12, the second step 114 can include a tang 166 that extends upward from the second step 114 away from the first step 112. The second step 114 can include a plurality of tangs 166 that extend upward from the second step 114. For example, as illustrated in FIG. 12, the second step 114 includes two tangs 166 that extend upward from the second step 114. The tang 166 of the second step 114 can extend upward at the laterally-distal end 156 of the second step 114. For example, as illustrated in FIG. 12, the two tangs 166 of the second step 114 extend upward from the second step 114 at the left and right laterally-distal ends 160, 158 of the second step 114, respectively. In various implementations, the tang 166 of the second step 114 can extend upward from the upper stepping surface 162 of the second step 114 further than the traction ridges 164 of the second step 114 extend upward from the upper stepping surface 162 of the second step 114. In some embodiments, one or more of the tangs 166 of the first and second steps 112, 114 are laterally aligned with each other. In other words, the tang 166 of the first step 112 and the tang 166 of the second step 114 may be positioned relative to each other such that both tangs 166 fall within a plane extending normal to the lateral direction. In the embodiment illustrated in FIG. 12, the tang 166 positioned at the left laterally-distal end 160 of the first step 112 is laterally aligned with the tang 166 positioned at the left laterally-distal end 160 of the second step 114. Further, the tang 166 positioned at the right laterally-distal end 158 of the first step 112 is laterally aligned with the tang 166 positioned at the right laterally-distal end 158 of the second step 114.

In some embodiments, the first step 112 can include at least one tang 166 that extends upward from the laterally-distal ends 156 of the first step 112. For example, in the embodiment illustrated in FIG. 12, two tangs 166 extend upward from the left and right laterally-distal ends 160, 158 of the first step 112, and two tangs 166 extend downward from the left and right laterally-distal ends 160, 158 of the first step 112. In operation, the upward extending tangs 166 of the first and second steps 112, 114, which extend upward from the laterally-distal ends 156 of the first and second steps 112, 114, respectively, can serve as a tactile indication of where the laterally-distal ends 156 of the first and second steps 112, 114 are while the user is climbing. Further, the downward extending tangs 166 of the first step 112 and the upward extending tangs 166 of the second step 114 may act as hooks that can retain rope coiled about the first and second steps 112, 114.

Referring now to FIGS. 12 and 13, the first and/or second steps 112, 114 can define a plurality of step recesses 168. In various embodiments, the front side of the first step 112 and/or the front side of the second step 114 define the plurality of step recesses 168. As illustrated in FIG. 12, the plurality of step recesses 168 may be separated from each other and partially defined by one or more step walls 170. As illustrated in FIG. 12, the step walls 170 may extend generally parallel to the length of the post 116 and may have substantially the same lateral width as the inner wall 128 of the post 116. The first and/or second steps 112, 114 defining step recesses 168 separated by the step walls 170 may advantageously influence the flow of resin and the orientation of fibers 192 within the climbing stick 110 during the injection molding process, such that the structural integrity of the climbing stick 110 is enhanced.

Referring now to FIGS. 12-17, the climbing stick 110 includes at least one standoff 172. The at least one standoff 172 is configured to engage with a tree while the climbing stick 110 is in use. In various embodiments, the climbing stick 110 includes a plurality of standoffs 172 that are configured to engage with a tree. The at least one standoff 172 can extend rearward from the first and/or second steps 112, 114 of the climbing stick 110. In the embodiment illustrated in FIG. 14, the climbing stick 110 includes two standoffs 172 that extend rearward from the first step 112 and two standoffs 172 that extend rearward from the second step 114. As illustrated in FIG. 14, each standoff 172 of the climbing stick 110 is positioned laterally between one of the laterally-distal ends 156 of the first and second steps 112, 114 and the post 116 of the climbing stick 110. As shown in FIG. 14, upper surfaces 174 of the standoffs 172 that extend rearward from the first step 112 may be substantially flush with the upper stepping surface 162 of the first step 112 adjacent to the first step 112. Further, the upper surfaces 174 of the standoffs 172 that extend rearward from the second step 114 may be substantially flush with the upper stepping surface 162 of the second step 114 adjacent to the second step 114.

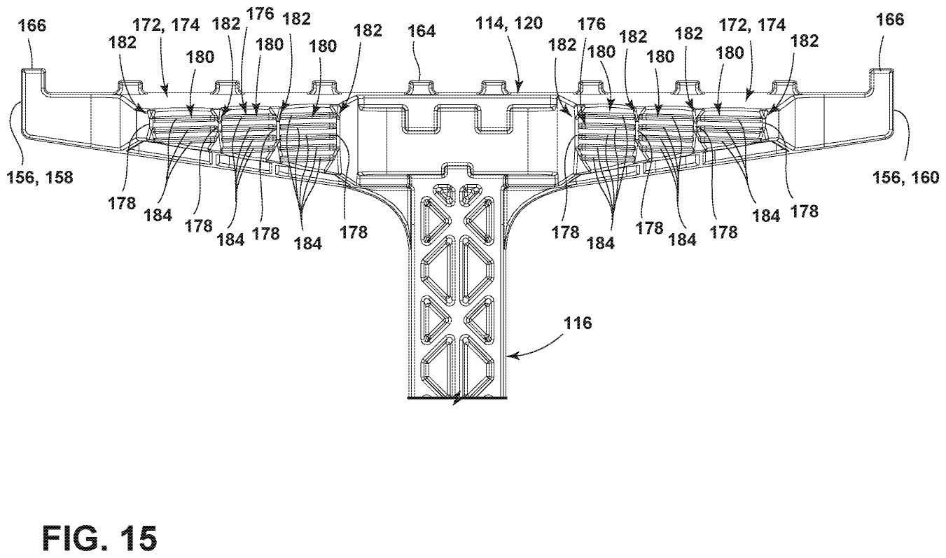

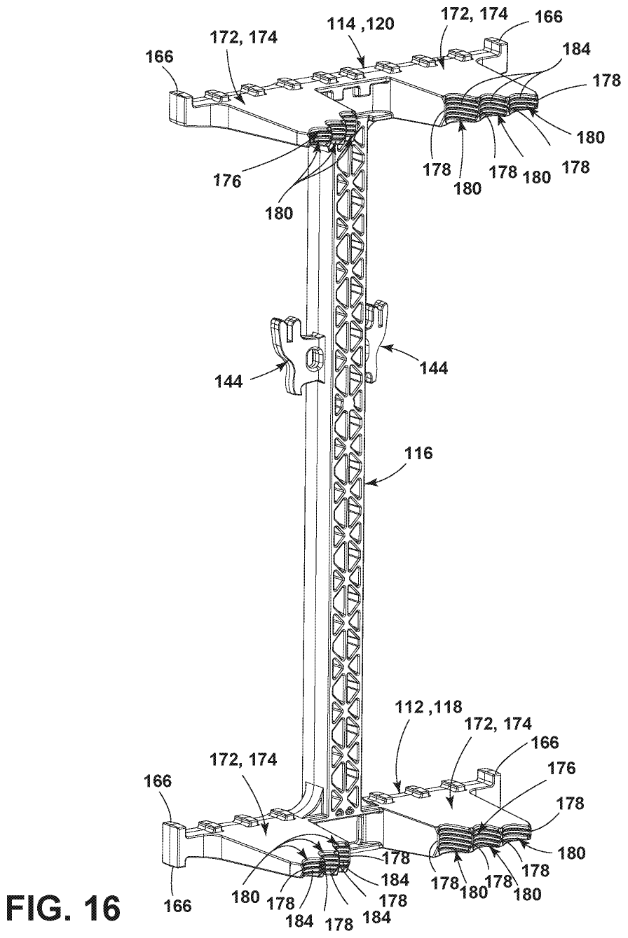

Referring now to FIGS. 14-16, the at least one standoff 172 coupled to the first and/or second steps 112, 114 may include a rear wall 176. In the embodiment illustrated in FIG. 14, the standoff 172 extends rearward from the first step 112 to a rear wall 176 of the standoff 172. The rear wall 176 of the standoff 172 includes a plurality of ridges 178 and a plurality of valleys 180 arranged in alternating fashion to form a plurality of teeth 182. As illustrated in FIG. 14, the at least one standoff 172 coupled to the second step 114 may extend rearward from the second step 114 to a rear wall 176 of the at least one standoff 172 that includes a plurality of ridges 178 and a plurality of valleys 180 arranged in alternating fashion to form a plurality of teeth 182. In various implementations, at least one of the plurality of valleys 180 may define a plurality of grooves 184. For example, in the embodiment illustrated in FIG. 15, each of the plurality of valleys 180 of the rear wall 176 of the at least one standoff 172 defines a plurality of grooves 184. In some implementations, the plurality of grooves 184 may be substantially parallel to each other. In some embodiments, the plurality of grooves 184 extend laterally along the at least one of the plurality of valleys 180. In some implementations, the plurality of grooves 184 extend along the at least one of the plurality of valleys 180 substantially perpendicularly to the lengthwise direction of the post 116.

In the embodiment illustrated in FIGS. 14 and 15, each of the plurality of valleys 180 defined on the rear walls 176 of the two standoffs 172 that extend rearward from each of the first and second steps 112, 114 defines a plurality of grooves 184, and the grooves 184 of each respective valley 180 are substantially parallel with each other.

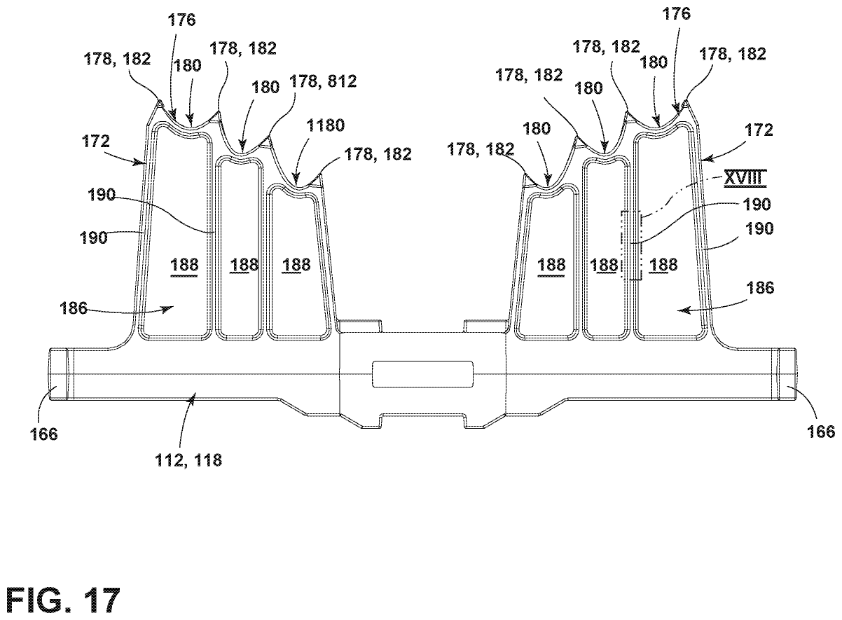

In various embodiments, a bottom side 186 of the at least one standoff 172 of the climbing stick 110 defines a plurality of standoff recesses 188. The plurality of standoff recesses 188 can be separated from each other and/or partially defined by a plurality of standoff ribs 190, as illustrated in FIG. 17. At least one standoff rib 190 may extend rearward from the first and/or second steps 112, 114 along a length of the at least one standoff rib 190. In some implementations, one or more standoff ribs 190 may extend rearward from the first and/or second steps 112, 114 and generally align with one or more of the plurality of ridges 178 of the rear wall 176 of the at least one standoff 172, as illustrated in FIG. 17. In some implementations, the length of the at least one standoff rib 190 may be substantially perpendicular to the length of the post 116. The at least one standoff 172 having a plurality of standoff recesses 188 that are separated by and partially defined by standoff ribs 190 may advantageously influence the flow of resin and the orientation of fibers 192 during injection molding of the climbing stick 110, such that the structural integrity of the climbing stick 110 is enhanced. Further, the orientation of fibers 192 within the at least one standoff rib 190 may enhance the structural integrity of the at least one standoff 172, as described further herein.

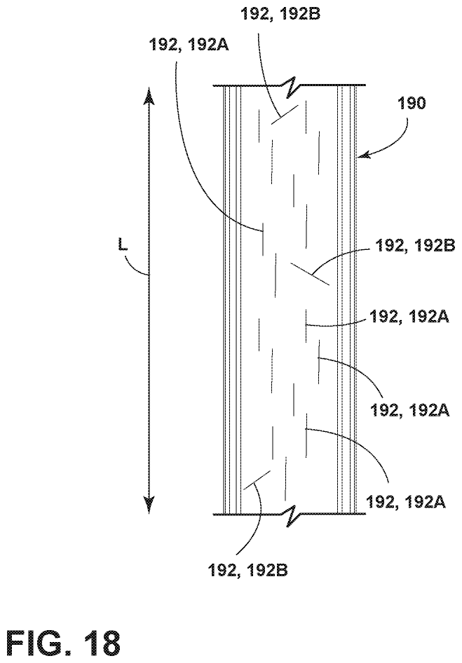

Referring now to FIGS. 17 and 18, the climbing stick 110 can be an injection-molded climbing stick 110. As such, the climbing stick 110 may be formed of a resin that is injected into a mold and cooled to form an integral component. A variety of types of resins, such as thermoplastics, are contemplated. Further, a variety of types of thermoplastics are contemplated. The injection-molded climbing stick 110 may further be formed of a plurality of fibers 192 that are disposed within the resin. A variety of types of fibers 192 are contemplated. For example, the injection-molded climbing stick 110 may include one or more of a host of types of fibers 192 that may include, but is not limited to, carbon, glass, aramid, basalt, polyacrylonitrile, polyethylene terephthalate, and/or polypropylene fibers. Further, the injection-molded climbing stick 110 can include long fibers and/or short fibers. In an exemplary embodiment, the injection-molded climbing stick 110 is formed of a thermoplastic resin and short carbon fibers. As such, the climbing stick 110 is a short carbon fiber-reinforced thermoplastic climbing stick 110. Various combinations of resins and fibers are contemplated. In various embodiments, fibers 192 disposed within the climbing stick 110 are aligned with each other and/or aligned with a given climbing stick-direction to enhance the structural integrity of the climbing stick 110. For example, fibers disposed within the inner wall 128 and/or the outer walls 124, 126 of the post 116 of the climbing stick 110 may be aligned with each other along a length of the post 116.

With reference to FIGS. 17 and 18, in some embodiments, fibers 192 disposed within the at least one standoff rib 190 are aligned with each other along the length of the standoff rib 190. In an exemplary embodiment, wherein the standoff rib 190 extends rearward from the first step 112 along the length of the standoff rib 190, the standoff rib 190 comprises a plurality of fibers 192 that includes every fiber 192 that is disposed within the standoff rib 190 of the climbing stick 110. The plurality of fibers 192 within the standoff rib 190 includes a sub-plurality of fibers 192A. Each fiber 192A in the sub-plurality of fibers 192A is elongated in the lengthwise direction of the fiber 192A. Further, each fiber 192A in the sub-plurality of fibers 192A is oriented such that the lengthwise direction is substantially parallel to the length of the standoff rib 190. In various embodiments, the plurality of fibers 192 that includes every fiber 192 that is disposed within the standoff rib 190 includes fibers 192B that are not oriented such that the lengthwise direction of the fiber 192B is substantially parallel to the length of the standoff rib 190. In various embodiments, the sub-plurality of fibers 192A includes a majority of the fibers 192 in the plurality of fibers 192 disposed within the standoff rib 190. In some embodiments, the sub-plurality of fibers 192A includes between about 60% and 100% of the fibers 192 in the plurality of fibers 192 disposed within the standoff rib 190. In some embodiments, the sub-plurality of fibers 192A includes between about 75% and 100% of the fibers 192 in the plurality of fibers 192 disposed within the standoff rib 190. In some embodiments, the sub-plurality of fibers 192A includes between about 90% and 100% of the fibers 192 in the plurality of fibers 192 disposed within the standoff rib 190. In some embodiments, the sub-plurality of fibers 192A includes between about 95% and 100% of the fibers 192 in the plurality of fibers 192 disposed within the standoff rib 190. In some embodiments, the sub-plurality of fibers 192A includes between about 99% and 100% of the fibers 192 in the plurality of fibers 192 disposed within the standoff rib 190.

In various embodiments, fibers 192 are oriented substantially parallel to the length L of the standoff rib 190 when the lengthwise direction of the fiber 192 is angled less than about 30° relative to the length L of the standoff rib 190. In some embodiments, substantially parallel to the length L of the standoff rib 190 is an angle of less than about 15° relative to the length L of the standoff rib 190. In some embodiments, substantially parallel to the length L of the standoff rib 190 is an angle of less than about 10° relative to the length L of the standoff rib 190. In some embodiments, substantially parallel to the length L of the standoff rib 190 is an angle of less than about 5° relative to the length L of the standoff rib 190. In various implementations, the sub-plurality of fibers 192A in the standoff rib 190 may be oriented such that they are substantially perpendicular to the length of the post 116 of the climbing stick 110.

The present disclosure may provide a variety of advantages. First, forming the climbing stick 110 of a thermoplastic resin via injection molding results in the climbing stick 110 being significantly lighter than similarly sized climbing sticks that are formed of conventional materials, such as metal. Second, despite the reduced weight of the climbing stick 110 enabled by use of the thermoplastic material, the sub-plurality of fibers 192A that are oriented substantially parallel with the length of the standoff rib 190 and the strategic orientation of fibers to be substantially parallel with the length of the post 116 in the inner and outer walls 128, 124, 126 of the post 116 may ensure that the climbing stick 110 has sufficient structural integrity for conventional use. Third, the post 116 including the inner and outer walls 128, 124, 126 and the pluralities of first and second diagonal walls 132, 134 may further contribute to the structural integrity of the climbing stick 110. Fourth, the valleys 180 of the rear wall 176 of the at least one standoff 172 including the plurality of grooves 184 may allow the at least one standoff 172 to more effectively engage a tree that the climbing stick 110 is mounted to, such that squeaking and other undesirable noise caused by movement of the climbing stick 110 relative to the tree during use of the climbing stick 110 is satisfactorily reduced.

According to an aspect of the present disclosure, an injection-molded climbing stick includes a first step, a second step, and a post extending from the first step to the second step along a length of the post and comprising a plurality of fibers that includes every fiber that is disposed within the post. The plurality of fibers includes a sub-plurality of fibers. Further, each fiber in the sub-plurality of fibers is elongated in a lengthwise direction of the fiber and oriented such that the lengthwise direction is substantially parallel to the length of the post, and the sub-plurality of fibers includes a majority of the fibers in the plurality of fibers.

According to another aspect, the sub-plurality of fibers includes between about 60 percent and 100 percent of the fibers in the plurality of fibers.

According to another aspect, the sub-plurality of fibers includes between about 75 percent and 100 percent of the fibers in the plurality of fibers.

According to another aspect, the sub-plurality of fibers includes between about 90 percent and 100 percent of the fibers in the plurality of fibers.

According to another aspect, substantially parallel to the length of the post is an angle of less than about 30 degrees relative to the length of the post.

According to another aspect, substantially parallel to the length of the post is an angle of less than about 15 degrees relative to the length of the post.

According to another aspect, substantially parallel to the length of the post is an angle of less than about 10 degrees relative to the length of the post.

According to another aspect, substantially parallel to the length of the post is an angle of less than about 5 degrees relative to the length of the post.

According to another aspect, a cleat is coupled to the post between the first and second steps and includes a neck coupled to the post and extending outward therefrom and a head coupled to the neck distally from the post and wholly defining a slot.

According to another aspect, the cleat defines a cleat aperture.

According to another aspect, the cleat angles forward and laterally-outboard from the post.

According to another aspect, the first step is a bottom step and the second step is a top step positioned upward of the bottom step, and the slot defined by the head of the cleat faces generally upward toward the top step.

According to another aspect, the post includes a first outer wall that extends in a lengthwise direction of the post, a second outer wall that extends in the lengthwise direction of the post, an inner wall that extends in the lengthwise direction of the post and is positioned between the first and second outer walls, a first floor portion that extends in the lengthwise direction of the post and extends between the first outer wall and the inner wall, and a second floor portion that extends in the lengthwise direction of the post and extends between the second outer wall and the inner wall. The first outer wall, the inner wall, and the first floor portion define a first channel that extends along the lengthwise direction of the post, and the second outer wall, the inner wall, and the second floor portion define a second channel that extends along the lengthwise direction of the post.

According to another aspect, the inner wall at least partially defines an aperture that extends through the post.

According to another aspect, a first protrusion extends outward from one of the first and second steps and is laterally aligned with the first channel. A lateral width of the first protrusion is less than a lateral width of the first channel. Further, a second protrusion extends outward from one of the first and second steps and is laterally aligned with the second channel. A lateral width of the second protrusion is less than a lateral width of the second channel.

According to another aspect, the first protrusion extends outward from the first step in a forward direction.

According to another aspect, the first step is a bottom step and the second step is a top step positioned upward of the bottom step, and the first step includes a tang that extends downward from the first step away from the second step.

According to another aspect, the second step includes a tang that extends upward from the second step and away from the first step. The tangs of the first and second steps are laterally aligned with each other.

According to another aspect, a standoff extends rearward from the first step.

According to yet another aspect, a front side of the first step defines a plurality of step recesses, and a bottom side of the standoff defines a plurality of standoff recesses.

According to one aspect of the disclosure, an injection-molded climbing stick includes a first step, a second step, a post extending from the first step to the second step along a length of the post, and a standoff. The post includes a first outer wall that extends in a lengthwise direction of the post, a second outer wall that extends in the lengthwise direction of the post, an inner wall that extends in the lengthwise direction of the post and is positioned between the first and second outer walls, a plurality of first diagonal walls each of which extends upward and rightward from the first outer wall to the second outer wall, a plurality of second diagonal walls each of which extends upward and leftward from the second outer wall to the first outer wall, a first floor portion that extends in the lengthwise direction of the post and extends between the first outer wall and the inner wall, and a second floor portion that extends in the lengthwise direction of the post and extends between the second outer wall and the inner wall. The first floor portion is interrupted by the pluralities of first and second diagonal walls. Further, the second floor portion is interrupted by the pluralities of first and second diagonal walls. The standoff extends rearward from the first step to a rear wall of the standoff and includes a plurality of ridges and a plurality of valleys arranged in alternating fashion to form a plurality of teeth. At least one of the plurality of valleys defines a plurality of grooves.

According to another aspect, each of the plurality of valleys defines a plurality of grooves.

According to another aspect, the plurality of grooves are substantially parallel to each other.

According to another aspect, the plurality of grooves extends laterally along the at least one of the plurality of valleys.

According to another aspect, the plurality of grooves extends along the at least one of the plurality of valleys substantially perpendicularly to the lengthwise direction of the post.

According to another aspect, the first outer wall, the inner wall, the plurality of first diagonal walls, the plurality of second diagonal walls, and the first floor portion cooperate to define a plurality of first pockets disposed along the post.

According to another aspect, the second outer wall, the inner wall, the plurality of first diagonal walls, the plurality of second diagonal walls, and the second floor portion cooperate to define a plurality of second pockets disposed along the length of the post.

According to another aspect, the standoff includes at least one standoff rib that extends rearward from the first step along a length of the at least one standoff rib, the at least one standoff rib comprising a plurality of fibers that includes every fiber that is disposed within the at least one standoff rib. The plurality of fibers includes a sub-plurality of fibers. Each fiber in the sub-plurality of fibers is elongated in a lengthwise direction of the fiber and oriented such that the lengthwise direction is substantially parallel to the length of the at least one standoff rib. Further, the sub-plurality of fibers includes a majority of the fibers in the plurality of fibers.

According to another aspect, the length of the post is substantially perpendicular to the length of the at least one standoff rib.

According to another aspect, the at least one standoff rib aligns with at least one of the plurality of ridges of the rear wall of the standoff.

According to another aspect of the disclosure, a climbing stick includes a first step, a second step, and a post extending from the first step to the second step along a length of the post. The post includes a first outer wall that extends in a lengthwise direction of the post, a second outer wall that extends in the lengthwise direction of the post, an inner wall that extends in the lengthwise direction of the post and is positioned between the first and second outer walls, a plurality of first diagonal walls each of which extends upward and rightward from the first outer wall to the second outer wall, a plurality of second diagonal walls each of which extends upward and leftward from the second outer wall to the first outer wall, a first floor portion that extends in the lengthwise direction of the post and extends between the first outer wall and the inner wall, and a second floor portion that extends in the lengthwise direction of the post and extends between the second outer wall and the inner wall. The first floor portion is interrupted by the pluralities of first and second diagonal walls. Further, the second floor portion is interrupted by the pluralities of first and second diagonal walls.

According to another aspect, the first outer wall, the inner wall, the plurality of first diagonal walls, the plurality of second diagonal walls, and the first floor portion cooperate to define a plurality of first pockets disposed along the post.

According to another aspect, the second outer wall, the inner wall, the plurality of first diagonal walls, the plurality of second diagonal walls, and the second floor portion cooperate to define a plurality of second pockets disposed along the length of the post.

According to another aspect, a standoff extends rearward from the first step to a rear wall of the standoff and includes a plurality of ridges and a plurality of valleys arranged in alternating fashion to form a plurality of teeth. At least one of the plurality of valleys defines a plurality of grooves.

According to another aspect of the disclosure, an injection-molded climbing stick includes a first step, a second step, a post extending from the first step to the second step along a length of the post, and a standoff extending rearward from the first step to a rear wall of the standoff that includes a plurality of ridges and a plurality of valleys arranged in alternating fashion to form a plurality of teeth, wherein at least one of the plurality of valleys defines a plurality of grooves.

According to another aspect, each of the plurality of valleys defines a plurality of grooves.

According to another aspect, the plurality of grooves are substantially parallel to each other.

According to another aspect, the plurality of grooves extends laterally along the at least one of the plurality of valleys.

According to another aspect, the plurality of grooves extends along the at least one of the plurality of valleys substantially perpendicularly to the lengthwise direction of the first post.

According to another aspect, the climbing stick is an injection molded climbing stick, and the standoff includes at least one standoff rib that extends rearward from the first step along a length of the at least one standoff rib, the at least one standoff rib comprising a plurality of fibers that includes every fiber that is disposed within the at least one standoff rib. The plurality of fibers includes a sub-plurality of fibers. Each fiber in the sub-plurality of fibers is elongated in a lengthwise direction of the fiber and oriented such that the lengthwise direction is substantially parallel to the length of the at least one standoff rib. Further, the sub-plurality of fibers includes a majority of the fibers in the plurality of fibers.

It will be understood by one having ordinary skill in the art that construction of the described disclosure and other components is not limited to any specific material. Other exemplary embodiments of the disclosure disclosed herein may be formed from a wide variety of materials, unless described otherwise herein.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A climbing stick comprising:
first and second steps;
a post that extends between the first and second steps; and
a standoff having a standoff body that extends rearward of the first step to a rear wall of the standoff that includes a plurality of ridges and at least one valley arranged in alternating fashion to form a plurality of teeth, the standoff body of the standoff having an upper surface, a lower surface that faces away from the upper surface, a laterally-inboard side surface, and a laterally-outboard side surface that faces away from the laterally-inboard side surface, wherein at least one of the upper surface and the lower surface of the standoff body is angled such that the vertical thickness of the standoff body from the upper surface to the lower surface decreases as the upper and lower surfaces extend toward the rear wall, and wherein at least one of the laterally-inboard and laterally-outboard side surfaces is angled such that the lateral thickness of the standoff from the laterally-inboard side surface to the laterally-outboard side surface decreases as the laterally-inboard and laterally-outboard side surfaces extend toward the rear wall.

2. The climbing stick of claim 1, wherein at least one of the upper surface and the lower surface of the standoff body is angled such that the vertical thickness of the standoff body from the upper surface to the lower surface decreases as the upper and lower surfaces extend away from the laterally-inboard side surface toward the laterally-outboard side surface.

3. The climbing stick of claim 1, wherein the standoff body extends from the first step to the rear wall of the standoff.

4. The climbing stick of claim 3, wherein the upper surface of the standoff body is substantially flush with an upper stepping surface of the first step where the upper surface of the standoff body is adjacent to the upper stepping surface.

5. The climbing stick of claim 1, wherein the standoff body includes a plurality of standoff walls that at least partially define a plurality of standoff recesses, wherein the standoff walls include vertically-facing surfaces.

6. The climbing stick of claim 5, wherein an underside of the standoff body includes the plurality of standoff walls and the vertically-facing surfaces are downward-facing surfaces, and wherein the downward-facing surfaces form the lower surface of the standoff body.

7. The climbing stick of claim 5, wherein at least one of the standoff walls comprises a plurality of fibers that includes every fiber that is disposed within the at least one standoff wall, and wherein the plurality of fibers includes a sub-plurality of fibers, wherein each fiber in the sub-plurality of fibers is elongated in a lengthwise direction of the fiber and oriented such that the lengthwise direction is substantially parallel to the length of the at least one standoff wall, and wherein the sub-plurality of fibers includes a majority of the fibers in the plurality of fibers.

8. The climbing stick of claim 1, wherein said climbing stick is an injection-molded climbing stick.

9. The climbing stick of claim 3, wherein the standoff is a first standoff that includes the standoff body that extends from the first step, and said climbing stick further comprises:
a second standoff that includes a standoff body that extends from the first step to a rear wall of the second standoff.

10. The climbing stick of claim 9, wherein the post is laterally-spaced apart from the first and second standoffs.

11. The climbing stick of claim 1, wherein the first step includes an upper stepping surface that faces upward and is configured to support the foot of a user, and the first step includes a lower step surface that faces away from the upper stepping surface, wherein, along a portion of the first step that is disposed laterally-outboard of the post in a first lateral direction, at least one of the upper stepping surface and the lower step surface is angled such that the vertical thickness, from the upper stepping surface to the lower step surface, of the portion of the first step decreases as the upper stepping surface and the lower step surface extend laterally outboard in the first lateral direction.

12. The climbing stick of claim 1, wherein the first step includes a front side, and the front side of the first step defines a plurality of step recesses that are separated from each other by one or more step walls.

13. A climbing stick comprising:
first and second steps;
a post that extends between the first and second steps; and
a standoff having a standoff body that extends rearward of the first step to a rear wall of the standoff that includes a plurality of ridges and at least one valley arranged in alternating fashion to form a plurality of teeth, wherein the standoff body tapers vertically as the standoff extends rearwardly, and the standoff body tapers laterally as the standoff extends rearwardly.

14. The climbing stick of claim 13, wherein the standoff body tapers vertically as the standoff body extends laterally-outboard.

15. The climbing stick of claim 13, wherein said climbing stick is an injection-molded climbing stick.

16. The climbing stick of claim 13, wherein the standoff body extends from the first step to the rear wall of the standoff.

17. The climbing stick of claim 13, wherein the first step includes a front side, and the front side of the first step defines a plurality of step recesses that are separated from each other by one or more step walls.

18. A climbing stick comprising:
first and second steps;
a post that extends between the first and second steps; and
a standoff having a standoff body that extends rearward of the first step to a rear wall of the standoff that includes a plurality of ridges and at least one valley arranged in alternating fashion to form a plurality of teeth, wherein the standoff body tapers vertically as the standoff extends rearwardly and tapers vertically as the standoff body extends laterally outboard.

19. The climbing stick of claim 18, wherein the standoff body tapers laterally as the standoff extends rearwardly.

20. The climbing stick of claim 18, wherein the first step includes a front side, and the front side of the first step defines a plurality of step recesses that are separated from each other by one or more step walls.

21. The climbing stick of claim 20, wherein said climbing stick is an injection-molded climbing stick.
